(19) United States
(12) Patent Application Publication
(10) Pub. No.: US 2022/0292203 A1
(43) Pub. Date: Sep. 15, 2022

(54) TECHNOLOGIES FOR DEVICE ATTESTATION

(71) Applicant: Intel Corporation, Santa Clara, CA (US)

(72) Inventors: Christine E. SEVERNS-WILLIAMS, Deephaven, MN (US); Nikola RADOVANOVIC, Los Altos, CA (US); Lev FAERMAN, Ramat Gan (IL); Amir SAHAR, Kfar Saba (IL); Marek ZMUDA, Rumia (PL)

(21) Appl. No.: 17/827,608

(22) Filed: May 27, 2022

(51) Int. Cl. G06F 21/60; G06F 21/64; G06F 21/57; G06F 21/33

(52) U.S. Cl. CPC G06F 21/602; G06F 21/64; G06F 21/572; G06F 21/33; G06F 2221/0751

(57) ABSTRACT

Examples described herein relate to software attestation. In some examples, circuitry is to generate measurements for software attestation of a device and wherein the circuitry is a sole generator of the measurements for software attestation for the device. In some examples, the measurements are based on one or more of: firmware image file, software executable binary, device state, and/or fuse measurements. In some examples, generate measurements for software attestation of the device includes performing a cryptographic hash over one or more of: firmware image file, software executable binary, device state, and/or fuse measurements.

### BACKGROUND

FIG. 1 depicts an example of connected devices that utilize a Remote Attestation Protocol. Remote Attestation (RA) is a security mechanism to remotely detect an adversarial presence on a device to guarantee the device's trustworthiness. RA runs as a two-party security protocol in which a trusted party (e.g., the requester) assures the integrity of the untrusted remote device (e.g., the responder). A requester can determine identity of device and what firmware or software the device is running. The responder sends proof about its current state (e.g., a cryptographic hash digest) to the requester. The requester evaluates the received evidence with the expected legitimate state (known in advance) of the responder, and validates whether the responder is trustworthy or not based on the state. RA protocol message exchanges may provide authentication of hardware identities, measurement of firmware and software identities and session key exchange protocols to enable confidentiality and integrity protected data communication. Many system-on-chip (SOC) and platforms utilize Remote Attestation Protocols.

FIG. 2 depicts an example of Message Exchange under Security Protocol and Data Model. Security Protocol and Data Model (SPDM) is an RA protocol defined by the Distributed Management Task Force (DMTF) and identified by Document Identifier DSP0274 version 1.1.2 (2022). More particularly, the messaging protocol is described in section 8 of SPDM. The SPDM protocol exchanges a series of messages between the requester and responder to perform remote attestation based on product identifier and hardware and firmware measurements.

### BRIEF DESCRIPTION OF THE DRAWINGS

FIG. 1 depicts an example system.

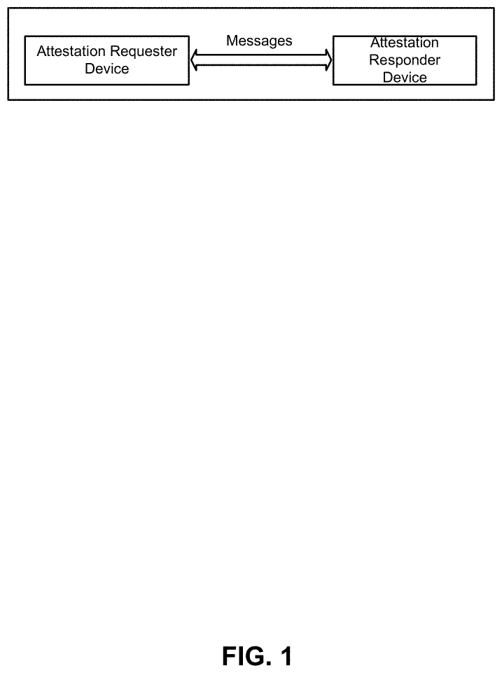

FIG. 2 depicts an example process.

FIG. 3 depicts an example system.

FIG. 4 depicts an example system.

FIG. 5 depicts an example process.

FIG. 6 depicts an example system.

### DETAILED DESCRIPTION

An RA architecture can be implemented in multiple manners. A software-based (e.g., firmware-based) RA architecture can be implemented. A hardware-based RA architecture can be implemented to use a tamper-resistant hardware, such as a Trusted Platform Module (TPM) as a secure execution environment. A hybrid RA architecture can utilize specialized hardware support to establish a hardware-based root of trust (RoT).

Trusted Computing Group's Device Identifier Composition Engine (DICE) specifications (e.g., “Hardware Requirements for a Device Identifier Composition Engine,” Level 00 Revision 78 (2018)) defines hardware RoT for attestation using a combination of hardware, immutable boot read only memory (ROM) code running on the device. Attestation RoT can create one or more asymmetric cryptographic key pairs from a unique device secret (UDS) from fuses or physically unclonable function (PUFs) by performing derivation of the UDS. UDS should be internally generated, and impossible to extract, even by a hardware manufacturer. Other values may be included in the creation of the asymmetric key pairs. The first key pair created by the device is the “DeviceID” key pair and is unique per device. Child asymmetric key pairs may also be created depending on the complexity of the device, the firmware, the boot sequence and the device's needs. The DeviceID or a child private key can be used to sign the attestation protocol messages to provide integrity and authentication for the messages and to prevent man-in-the-middle attacks. A Responder performs the signing.

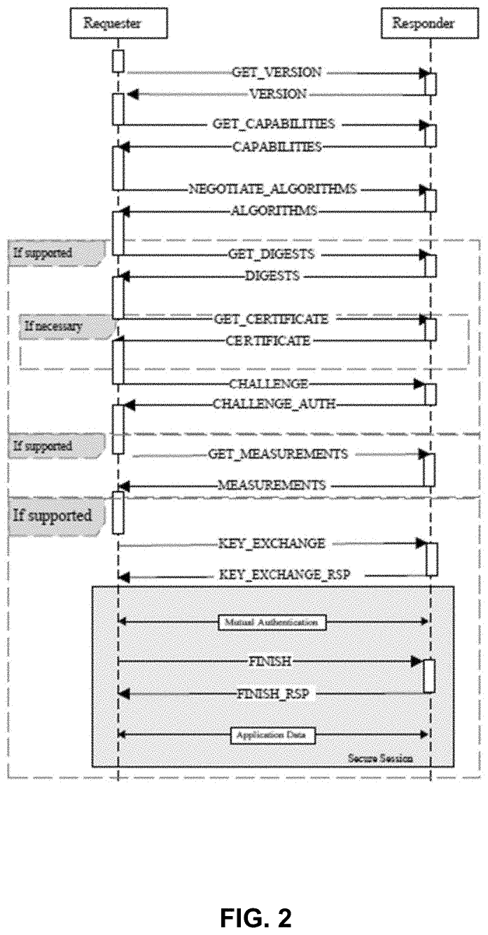

The Requester receives the DeviceID public key in a certificate to enable verification of the message signature. The DeviceID certificate can be rooted by a trusted Certificate Authority and the certificate chain may include some number of certificates between the Root Certificate and the DeviceID certificate. The Requester may have this certificate chain pre-installed and/or the Responder may deliver this certificate chain to the Requester as part of the RA protocol such as in the Get Certificate message exchange of FIG. 2. The DeviceID and child private keys may also be used during boot to create the key/certificate chain and sign the next child key in the sequence. The DeviceID private key and any child private keys created must be kept secret or the security of the RA protocol is broken.

DICE uses a cryptographic hash of the first mutable firmware or hashes of multiple layers of firmware in the calculation of the attestation RoT. This creates the situation that if the first mutable firmware changes, the attestation RoT values will change, rendering any created certificate chain, including the device certificate, invalid. DICE uses this implicit indication that the firmware was updated to invalidate the attestation RoT and all related certificates. When using DICE, if the firmware is updated, the device certificate and certificate chain back to the Root Certificate Authority must updated. For some devices, this update is not only challenging, but also not possible without recalling the device from the field, from a customer.

An RA protocol stack can execute in firmware, except for creation of the attestation RoT. This firmware includes using the DICE RoT secrets, taking measurements, inserting nonces and signing protocol messages and message transcripts. A message can refer to one or more messages or message transcript that include multiple messages. This can yield multiple opportunities for the security to be compromised if the firmware is compromised as the security guarantees are based on secrets and measurements the firmware or software creates, protects, and uses.

If system firmware or the system (e.g., system on chip (SoC)) is compromised during the boot process or later, the firmware or some external entity may: reveal or exfiltrate DICE, DeviceID and other private keys and RA protocol secrets; report spoofed evidence (e.g., measurements); gain access and possibly update secrets and measurements via leaks, software/hardware side-channels and error injection; or compromise symmetric key exchange implemented by some RA protocols (e.g., SPDM). Note that reference to SPDM or DSP0274 version 1.1.2 (2022) can refer to earlier versions, later versions, derivatives, or variations thereof. RA protocols other than SPDM can be utilized.

At least to potentially address integrity and security issues arising from compromised firmware, a hardware-based Immutable Attestation Security Circuitry (IASC) can perform one or more of: generating measurements, signing measurements, generating a key pair to use to sign messages and message transcripts sent to a requester, inserting signed measurements into one or more messages to be sent to a requester, or signing the one or more messages or message transcripts. IASC can perform security operations such as secure boot validation, secure debug authentication, secure storage and cryptography functions. IASC provides a secure trusted execution environment (TEE) which can protect the creation and usages of secrets, measurements, and other critical attestation variables. The attestation operations of the IASC are immutable and perform security operations concerning measurements without firmware. Even in the case of firmware compromise, the attestation solution security is not broken as the IASC is not impacted. Also, the IASC can avoid the problem where the device certificate and certificate chain are rendered invalid by a firmware update, allowing certificates to be valid over the lifetime of the device.

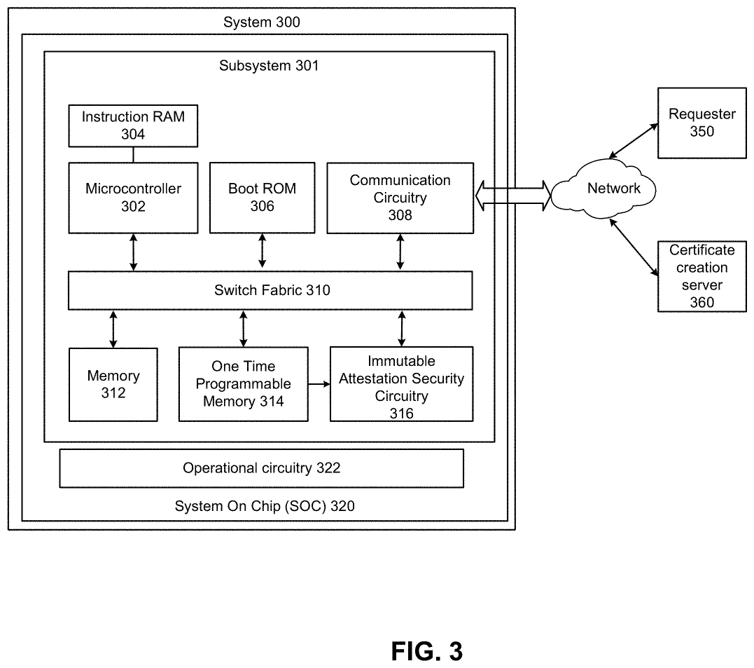

FIG. 3 depicts an example responder device. Microcontroller 302 can access instruction Random Access Memory (IRAM) 304 and/or boot read only memory (ROM) 306 to load instructions to execute at boot or re-boot of system 300. Microcontroller 302 can be implemented as a central processing unit or other processor device. Contents of boot ROM 306 can be trusted and can be unchanged after manufacture. Boot ROM 306 can be implemented as a hardware boot finite state machine (FSM) in some examples.

Microcontroller 302 can instruct Immutable Attestation Security Circuitry (IASC) 316 to perform operations related to attestation of system 300 including generating measurements, signing measurements, generating key pairs, inserting measurements into one or more messages, and signing messages or message transcripts, as described herein. IASC 316 can be a trusted device and unchanged after manufacture. Examples of instructions issued by microcontroller 302 to IASC 316 include: generate measurements, calculate hash, generate signature, verify signature, encrypt data, decrypt data, include measurements in message, Generate SPDM CHALLENGE Response Message, Generate SPDM MEASUREMENTS Response Message, Generate SPDM_KEY_EXCHANGE Response Message, and so forth.

One Time Programmable (OTP) memory 314 can store a Unique Device Secret (UDS). For example, a UDS can store a random number or pseudo-random number provisioned at manufacture of SoC 320 or determined by a PUF and not revealed outside SoC 320 or even revealed to firmware executing on a processor in SoC 320. No two same devices are assigned a same device ID. For example, different instances of a certain CPU model have different device IDs. OTP memory 314 can be implemented as one or more of: fuses, anti-fuses, read only memory, PUFs, etc.

Memory 312 that can be used by microcontroller 302 and IASC 316 in order to store data. In some examples, memory 312 can include one or more of: one or more registers, one or more cache devices (e.g., level 1 cache (L1), level 2 cache (L2), level 3 cache (L3), last level cache (LLC)), volatile memory device, non-volatile memory device, or persistent memory device. For example, memory 312 can include static random access memory (SRAM) memory technology or memory technology consistent with high bandwidth memory (HBM), or double data rate (DDR), among others.

Switch fabric 310 or bus can provide communication among the circuitry within subsystem 301 such as microcontroller 302, boot ROM 306, communication circuitry 308, memory 312, OTP memory 314, and IASC 316.

Subsystem 301 and its IASC 316 can be used in a wide variety of systems 300 from servers to low-cost Internet of things (IoT) devices as well as one or more of: microcontroller, central processing unit (CPU), graphics processing unit (GPU), network interface device, accelerator, storage device, memory device, graphics processing unit, audio or sound processing device, and so forth. In some examples, network interface device can refer to one or more of: a network interface controller (NIC), a remote direct memory access (RDMA)-enabled NIC, SmartNIC, router, switch, forwarding element, infrastructure processing unit (IPU), or data processing unit (DPU). Accordingly, system on chip (SoC) 320 can include operational circuitry 322 of one or more of: microcontroller, CPU, GPU, network interface device, accelerator, storage device, memory device (e.g., memory pool with dual inline memory modules (DIMMs)), graphics processing unit, audio or sound processing device, and so forth.

Communication circuitry 308 can provide communication with requestor 350 and/or certificate server 360. Communication circuitry 308 can include circuitry to provide communications consistent with various protocols including: I2C, Peripheral Component Interconnect express (PCIe), Ethernet, and others. Communication can be provided via wired or wireless media through a network or other connection. For wired communication, a port can provide communications with requester 350. In some examples, requester 350 can utilize protocols defined by SPDM to communicates through communication circuitry 308. In some examples, requester 350 can include a baseboard management controller (BMC).

In some examples, during a secure boot operation, IASC 316 can perform actions (1) to (4) to respond to remote attestation by providing product identifier and firmware and hardware measurements. At (1), system 300 commences secure boot by running boot firmware from boot ROM 306. In some examples, boot firmware code or firmware can include one or more of: Basic Input/Output System (BIOS), Universal Extensible Firmware Interface (UEFI), or a boot loader. The BIOS firmware can be pre-installed on a personal computer's system board or accessible through an SPI interface from a boot storage (e.g., flash memory). In some examples, a Universal Extensible Firmware Interface (UEFI) can be used instead or in addition to a BIOS for booting or restarting cores or processors. UEFI is a specification that defines a software interface between an operating system and platform firmware. UEFI can read from entries from disk partitions by not just booting from a disk or storage but booting from a specific boot loader in a specific location on a specific disk or storage. UEFI can support remote diagnostics and repair of computers, even with no operating system installed. A boot loader can be written for UEFI and can be instructions that a boot code firmware can execute and the boot loader is to boot the operating system(s). A UEFI bootloader can be a bootloader capable of reading from a UEFI type firmware.

A UEFI capsule is a manner of encapsulating a binary image for firmware code updates. But in some examples, the UEFI capsule is used to update a runtime component of the firmware code. The UEFI capsule can include updatable binary images with relocatable Portable Executable (PE) file format for executable or dynamic linked library (dll) files based on COFF (Common Object File Format). For example, the UEFI capsule can include executable (*.exe) files. This UEFI capsule can be deployed to a target platform as an SMM image via existing OS specific techniques (e.g., Windows Update for Azure, or LVFS for Linux).

At (2), during a boot operation, in response to calls to perform secure boot verification from requester 350 or execution of boot firmware code may cause system 300 to initiate secure boot verification, IASC 316 determines device identifier (ID) private key and stores the device ID private key in registers or memory within IASC 316, such that merely IASC 316 can write to and read from those registers or memory within IASC 316. For example, IASC 316 can determine the device identifier ID private key based on elliptical curve cryptography (ECC) (e.g., Elliptic Curve Digital Signature Algorithm (ECDSA) key pair). In some examples, in system 300, IASC 316 is the only software, firmware, or device that can create a device ID private key for system 300. The device ID private key can be used by IASC 316 to sign messages or message transcripts sent to requester 350. TCG DICE or layered DICE is not required as the DeviceID key pair can be created by IASC 316 without including the first mutable hash into the key derivation. Using the implicit attestation that DICE provides is not necessary as IASC 316 is trusted. After a product is sold to a customer, in field certificate updates or recalling product from the field for a certificate update is not needed because IASC 316 is trusted.

At (3), IASC 316 can determine measurements of firmware image files, hardware or device state during boot, and/or fuse values and store them in one or more regions in internal storage of IASC 316, in memory 312, or registers (not shown) and contents of such one or more regions in internal storage of IASC 316, in memory 312 or registers cannot be edited. To determine measurements of firmware image files, hardware or device state during boot, and/or fuse values, IASC 316 can perform a cryptographic hash calculation over firmware image files, hardware or device state during boot, and/or fuse values. In some examples, measurement operations can be consistent at least with section 10.11.3 “Measurements signature verification” of DSP0274 version 1.1.2 (2022). In accordance with DSP0274 version 1.1.2 (2022), a measurement can include a representation of firmware/software or configuration data on an endpoint. A measurement can include a cryptographic hash value of the data, or the raw data itself. IASC 316 can also verify an included image signature over the calculated measurements using an image signing public key stored in OTP 314 that is different than the DeviceID key pair.

At (4), IASC 316 can insert measurements into one or more messages and sign the one or more messages or message transcripts using device ID private key generated by IASC 316. Device ID private key can be stored in memory or registers in IASC 316. In some examples, IASC 316 is only device, software, and/or firmware that can respond to request for measurements and only one that can sign messages or message transcripts. Accordingly, even if firmware executed by system 300 is compromised, as firmware cannot sign messages or message transcripts with a proper key because it is not able to access the device ID private key, the returned measurements will fail and system 300 can be identified as tampered. Only IASC 316 can take, store, or edit measurements and successfully reply to signed RA protocol messages and firmware or software, which can be compromised, do not have access to the measurement storage or signing key (e.g., DeviceID private key or child key). Examples of messages include CHALLENGE_AUTH, MEASUREMENTS, KEY_EXCHANGE_RSP.

Based on invalid signed measurements or invalid signed messages or message transcripts, requester 350 can take corrective actions such as do not let a device boot, allow the device to boot but not perform work (e.g., isolate device from network), or update firmware or software in the device (e.g., system 300).

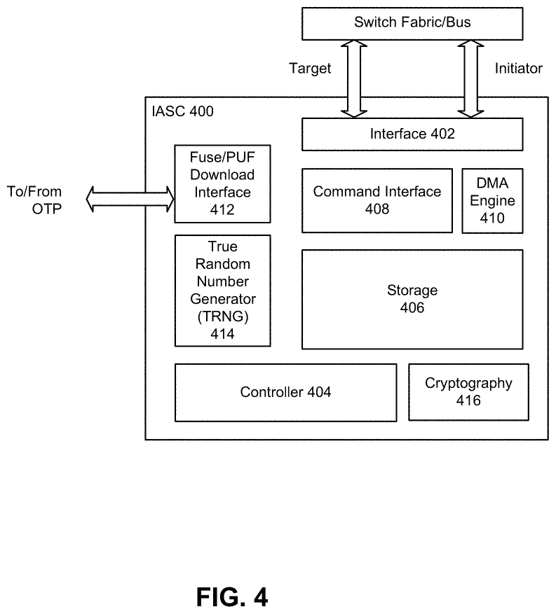

FIG. 4 depicts an example IASC. IASC 400 can read or write data or commands via interface 402. Commands may be issued to IASC 400 from microcontroller 302 based on boot ROM instructions in boot ROM 306. Microcontroller 302 can boot from boot ROM 306 so executed code making calls or commands to IASC 400 can be considered trusted.

Controller 404 can generate a device ID key-pair, generate and store measurements using cryptography circuitry 416, provide a signature for measurements using cryptography circuitry 416, insert signed measurements into one or more messages, and sign one or more messages or message transcripts, as described herein. In some examples, controller 404 can execute immutable code from ROM. In some examples, controller 404 can be implemented as fixed-function circuitry such as an application specific integrated circuitry (ASIC) whose operations cannot be changed after manufacture and testing.

Storage 406 can store one or more of the following data generated by control 404: DeviceID key pair, child key pair (if used), and generated measurements. Storage 406 can be implemented as volatile and/or non-volatile memory.

Command interface 408 can include registers and that stores functions IASC is requested to perform, such as generate measurements, signature generation, calculate hash, and so forth. Command interface 408 can receive commands from a microcontroller (e.g., microcontroller 302).

Direct memory access (DMA) engine 410 can be used to write read data to an address in memory or read data from an address in memory.

The following process can be performed by IASC 400 at boot. If the CPU supports a multi-stage boot, some of the tasks below may be called multiple times, once per boot stage. At (1), IASC 400 may download the Unique Device Secret (UDS) from the fuse controller or PUFs (e.g., One Time Programmable Memory 314). The UDS is obtainable from the fuse controller or physically unclonable function (PUFs) solely by IASC 400. At (2), IASC 400 may create the DeviceID asymmetric key pair of public and private keys based on UDS. UDS or DeviceID private key is not accessible outside of IASC 400 so that only IASC 400 can sign messages or message transcripts. IASC 400 may store the key pair in storage 406 or other memory or registers. IASC 400 may create child DeviceID alias key pair(s) per TCG and DMTF.

At (3), IASC 400 may securely export the DeviceID public key to a certificate creation server (e.g., certificate creation server 360). Certificate creation server 360 can create a DeviceID certificate and parent certificates. In some examples, certificate creation server 360 may create a certificate chain for the device that utilizes IASC 400 for attestation based on SPDM, Microsoft® Cerberus, Intel® Platform Firmware Resiliency (PFR), or others. A certificate chain rooted by certificate creation server can indicate a public key is trusted. A requester can use public key to verify measurements received from IASC 400.

At (4), IASC 400 may generate firmware and/or software measurement(s) and verify the firmware and/or software image(s) executing on a device that utilizes IASC 400. Verification can include (4A) to (4C), described next. At (4A), IASC 400 may perform cryptographic hashing of the firmware and/or software image(s) (e.g., executable binary) and headers based on National Institute of Standards and Technology Secure Hash Algorithm 1 (SHA-1), SHA-2, SHA-3, or other hashing schemes to generate a digest, which can represent measurements. Measurements may include a cryptographic hash of firmware and/or software image(s), fuse, and so forth.

At (4B), IASC 400 may check whether a public image signing key that would be used to sign the digest (e.g., measurements) is a revoked or expired key. IASC 400 may perform verification of the image signing key chain back to a RoT (e.g., hash of public key stored in OTP 314) to determine whether the public image signing key is properly to be used to generate measurements. A hash of a public key can be written at time of manufacture or test of device or updatable after device leaves manufacturer. In some cases, devices can be manufactured and shipped with multiple root keys and one or more root keys can be revoke if a key is compromised. If the public image signing key is verified, the public image signing key can be used to verify the measurements and the device can boot using the firmware and/or software. If the public image signing key is not verified, measurements are not stored and an indication can be made to a microcontroller that valid measurements are not available. Verification of the measurements can include verification of the signature over the expected and calculated measurements.

At (4C), IASC 400 may perform anti-rollback checking to disqualify use of formerly approved images based on revoked firmware or software security version numbers. OTP can store invalid security versions, written at time of manufacture or test of device or updatable after device leaves the manufacturer. If a version is approved, the public image signing key can be used to verify the measurements and the device can boot using the firmware and/or software. If a version is not approved, measurements are not stored and an indication can be made to a microcontroller that valid measurements are not available.

At (5), IASC 400 may store the measurement into storage 406 (e.g., registers or memory). In some examples, a measurement can only be stored once per boot cycle and are immutable (not modifiable) by IASC 400 or other circuitry, firmware, or software.

Actions (4) and (5) can be repeated for multi-stage boot to create different stored immutable measurements.

At (6), IASC 400 may calculate hardware measurements or device state and fuse measurements and store hardware measurements and fuse measurements in storage 406. Hardware measurements device state can indicate whether device in debug state during boot cycle. Fuse measurements can include public key for secure boot verification. Only IASC 400 can take and store the hardware measurements and fuse measurements into storage 406. In certain cases, hardware measurements and fuse measurements may be restricted to being taken and stored once per boot cycle.

At (7) IASC 400 may insert measurements and stored hardware and fuse measurements and nonces retrieved from a True Random Number Generator (TRNG) into attestation protocol messages. A nonce can be used for anti-replay so that signatures change for message transmission. At (8), IASC 400 may sign RA protocol messages with the DeviceID private key pair or child private key pair stored in storage 406. At (9), measurements and stored hardware and fuse measurements and nonces can be transmitted in attestation protocol messages to a requester. Based on SPDM, a message with a measurement (e.g., measurement message) is signed.

Note that with respect to FIG. 2, CHALLENGE, CHALLENGE_AUTH, GET_MEASUREMENTS, MEASUREMENTS, KEY_EXCHANGE, KEY_EXCHANGE_RSP involve measurements that are signed and verified using technologies described herein. Examples are described with respect to SPDM, but not limited to the SPDM RA protocol.

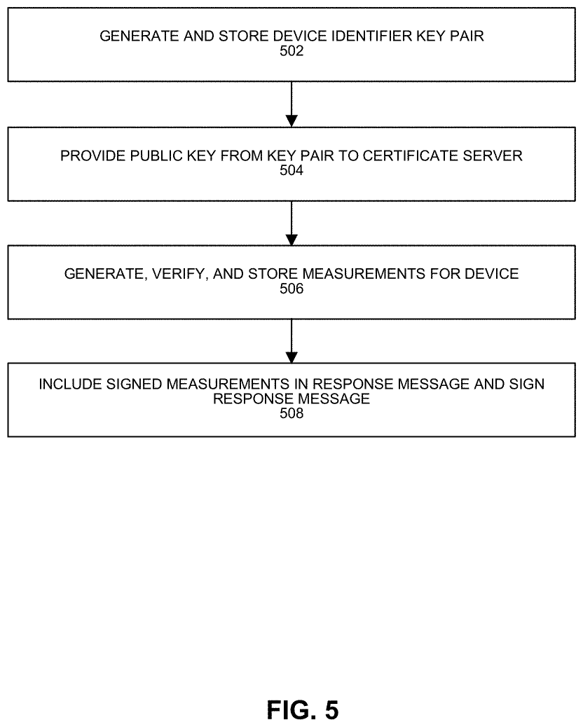

FIG. 5 depicts an example process. The process can take place during a boot or a re-boot of a device to determine whether the firmware and/or software executed by the device is approved for execution. The process can be performed by attestation circuitry associated with a device. At 502, attestation circuitry may generate and store device ID key pair based on a secret from a fuse controller or PUFs. DICE describes a manner to generate a device ID private key. Attestation circuitry can be the sole hardware, firmware, or software that can create a device ID private key.

At 504, attestation circuitry may provide device ID public key to a certificate server. The certificate server can use the create a certificate chain for the device that includes the circuitry.

At 506, attestation circuitry may generate measurements, verify the secure boot image measurements, and store measurements in storage. The measurements can be stored in a manner that measurements and signature cannot be edited and can only be written to by the attestation circuitry once per boot or re-boot. To generate measurements, attestation circuitry can perform a hash calculation over firmware image file, software executable binary, device state or hardware measurements, and/or fuse measurements. Device state and hardware measurements can indicate whether a device in debug state during boot cycle. Verifying the secure boot image can be based on a public key, where the public key is accessed from fused memory such as one-time programmable memory. The attestation circuitry can be the sole hardware, firmware, or software that can provide measurements and can sign measurements.

At 508, attestation circuitry can sign one or more response messages. In some examples, the response message can be signed based on the created device ID private key. The attestation circuitry can be only hardware, firmware, or software that can insert measurements into response messages sent to a requester and sign the message. Thereafter the signed response message with signed measurements is available to be transmitted to a requester or other trusted entity. A trusted entity can include a baseboard management controller (BMC) or orchestrator, in some examples.

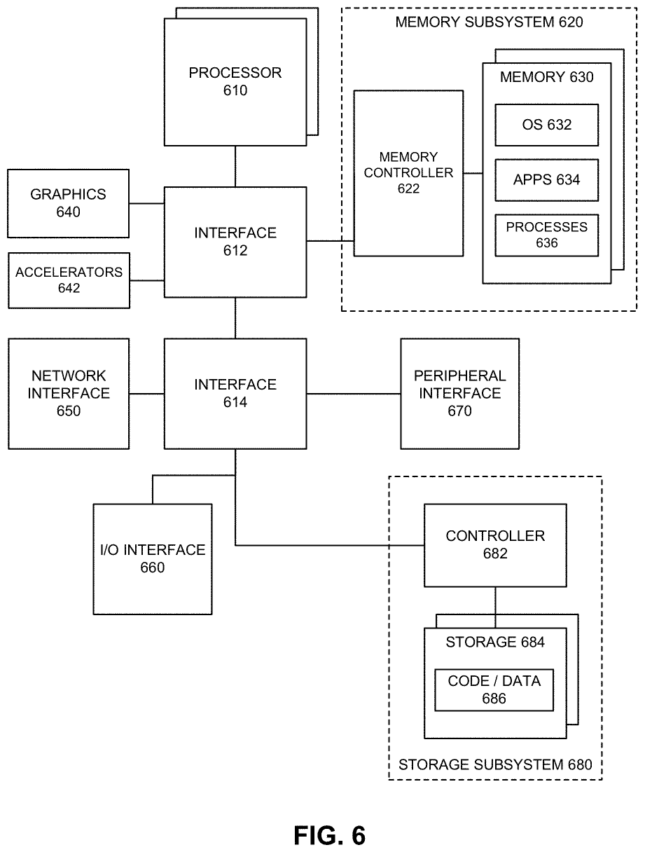

FIG. 6 depicts an example computing system. Components of system 600 (e.g., processor 610, accelerators 642, network interface 650, and so forth) can include an IASC to provide device measurements to a requester to attest and authenticate firmware and/or software executed by the device, as described herein. System 600 includes processor 610, which provides processing, operation management, and execution of instructions for system 600. Processor 610 can include any type of microprocessor, central processing unit (CPU), graphics processing unit (GPU), processing core, or other processing hardware to provide processing for system 600, or a combination of processors. Processor 610 controls the overall operation of system 600, and can be or include, one or more programmable general-purpose or special-purpose microprocessors, digital signal processors (DSPs), programmable controllers, application specific integrated circuits (ASICs), programmable logic devices (PLDs), or the like, or a combination of such devices.

In one example, system 600 includes interface 612 coupled to processor 610, which can represent a higher speed interface or a high throughput interface for system components that needs higher bandwidth connections, such as memory subsystem 620 or graphics interface components 640, or accelerators 642. Interface 612 represents an interface circuit, which can be a standalone component or integrated onto a processor die. Where present, graphics interface 640 interfaces to graphics components for providing a visual display to a user of system 600. In one example, graphics interface 640 can drive a high definition (HD) display that provides an output to a user. High definition can refer to a display having a pixel density of approximately 100 PPI (pixels per inch) or greater and can include formats such as full HD (e.g., 1080p), retina displays, 4K (ultra-high definition or UHD), or others. In one example, the display can include a touchscreen display. In one example, graphics interface 640 generates a display based on data stored in memory 630 or based on operations executed by processor 610 or both. In one example, graphics interface 640 generates a display based on data stored in memory 630 or based on operations executed by processor 610 or both.

Accelerators 642 can be a fixed function or programmable offload engine that can be accessed or used by a processor 610. For example, an accelerator among accelerators 642 can provide compression (DC) capability, cryptography services such as public key encryption (PKE), cipher, hash/authentication capabilities, decryption, or other capabilities or services. In some embodiments, in addition or alternatively, an accelerator among accelerators 642 provides field select controller capabilities as described herein. In some cases, accelerators 642 can be integrated into a CPU socket (e.g., a connector to a motherboard or circuit board that includes a CPU and provides an electrical interface with the CPU). For example, accelerators 642 can include a single or multi-core processor, graphics processing unit, logical execution unit single or multi-level cache, functional units usable to independently execute programs or threads, application specific integrated circuits (ASICs), neural network processors (NNPs), programmable control logic, and programmable processing elements such as field programmable gate arrays (FPGAs) or programmable logic devices (PLDs). Accelerators 642 can provide multiple neural networks, CPUs, processor cores, general purpose graphics processing units, or graphics processing units can be made available for use by artificial intelligence (AI) or machine learning (ML) models. For example, the AI model can use or include one or more of: a reinforcement learning scheme, Q-learning scheme, deep-Q learning, or Asynchronous Advantage Actor-Critic (A3C), combinatorial neural network, recurrent combinatorial neural network, or other AI or ML model. Multiple neural networks, processor cores, or graphics processing units can be made available for use by AI or ML models.

Memory subsystem 620 represents the main memory of system 600 and provides storage for code to be executed by processor 610, or data values to be used in executing a routine. Memory subsystem 620 can include one or more memory devices 630 such as read-only memory (ROM), flash memory, one or more varieties of random access memory (RAM) such as DRAM, or other memory devices, or a combination of such devices. Memory 630 stores and hosts, among other things, operating system (OS) 632 to provide a software platform for execution of instructions in system 600. Additionally, applications 634 can execute on the software platform of OS 632 from memory 630. Applications 634 represent programs that have their own operational logic to perform execution of one or more functions. Processes 636 represent agents or routines that provide auxiliary functions to OS 632 or one or more applications 634 or a combination. OS 632, applications 634, and processes 636 provide software logic to provide functions for system 600. In one example, memory subsystem 620 includes memory controller 622, which is a memory controller to generate and issue commands to memory 630. It will be understood that memory controller 622 could be a physical part of processor 610 or a physical part of interface 612. For example, memory controller 622 can be an integrated memory controller, integrated onto a circuit with processor 610.

While not specifically illustrated, it will be understood that system 600 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect (PCI) bus, a Hyper Transport or industry standard architecture (ISA) bus, a small computer system interface (SCSI) bus, a universal serial bus (USB), or an Institute of Electrical and Electronics Engineers (IEEE) standard 1394 bus (Firewire).

In one example, system 600 includes interface 614, which can be coupled to interface 612. In one example, interface 614 represents an interface circuit, which can include standalone components and integrated circuitry. In one example, multiple user interface components or peripheral components, or both, couple to interface 614. Network interface 650 provides system 600 the ability to communicate with remote devices (e.g., servers or other computing devices) over one or more networks. Network interface 650 can include an Ethernet adapter, wireless interconnection components, cellular network interconnection components, USB (universal serial bus), or other wired or wireless standards-based or proprietary interfaces. Network interface 650 can transmit data to a device that is in the same data center or rack or a remote device, which can include sending data stored in memory.

Network interface 650 can include one or more of: a network interface controller (NIC), a remote direct memory access (RDMA)-enabled NIC, Infrastructure Processing Unit (IPU), data processing unit (DPU), SmartNIC, router, switch, or network-attached appliance. Some examples of network interface 650 are part of an Infrastructure Processing Unit (IPU) or data processing unit (DPU) or utilized by an IPU or DPU. An xPU can refer at least to an IPU, DPU, GPU, GPGPU, or other processing units (e.g., accelerator devices). An IPU or DPU can include a network interface with one or more programmable pipelines or fixed function processors to perform offload of operations that could have been performed by a CPU.

In one example, system 600 includes one or more input/output (I/O) interface(s) 660. I/O interface 660 can include one or more interface components through which a user interacts with system 600 (e.g., audio, alphanumeric, tactile/touch, or other interfacing). Peripheral interface 670 can include any hardware interface not specifically mentioned above. Peripherals refer generally to devices that connect dependently to system 600. A dependent connection is one where system 600 provides the software platform or hardware platform or both on which operation executes, and with which a user interacts.

In one example, system 600 includes storage subsystem 680 to store data in a nonvolatile manner. In one example, in certain system implementations, at least certain components of storage 680 can overlap with components of memory subsystem 620. Storage subsystem 680 includes storage device(s) 684, which can be or include any conventional medium for storing large amounts of data in a nonvolatile manner, such as one or more magnetic, solid state, or optical based disks, or a combination. Storage 684 holds code or instructions and data 686 in a persistent state (e.g., the value is retained despite interruption of power to system 600). Storage 684 can be generically considered to be a “memory,” although memory 630 is typically the executing or operating memory to provide instructions to processor 610. Whereas storage 684 is nonvolatile, memory 630 can include volatile memory (e.g., the value or state of the data is indeterminate if power is interrupted to system 600). In one example, storage subsystem 680 includes controller 682 to interface with storage 684. In one example controller 682 is a physical part of interface 614 or processor 610 or can include circuits or logic in both processor 610 and interface 614.

A volatile memory is memory whose state (and therefore the data stored in it) is indeterminate if power is interrupted to the device. Dynamic volatile memory uses refreshing the data stored in the device to maintain state. One example of dynamic volatile memory incudes DRAM (Dynamic Random Access Memory), or some variant such as Synchronous DRAM (SDRAM). An example of a volatile memory include a cache. A memory subsystem as described herein may be compatible with a number of memory technologies, such as those consistent with specifications from JEDEC (Joint Electronic Device Engineering Council) or others or combinations of memory technologies, and technologies based on derivatives or extensions of such specifications.

A non-volatile memory (NVM) device is a memory whose state is determinate even if power is interrupted to the device. In one embodiment, the NVM device can comprise a block addressable memory device, such as NAND technologies, or more specifically, multi-threshold level NAND flash memory (for example, Single-Level Cell (“SLC”), Multi-Level Cell (“MLC”), Quad-Level Cell (“QLC”), Tri-Level Cell (“TLC”), or some other NAND). A NVM device can also comprise a byte-addressable write-in-place three dimensional cross point memory device, or other byte addressable write-in-place NVM device (also referred to as persistent memory), such as single or multi-level Phase Change Memory (PCM) or phase change memory with a switch (PCMS), Intel® Optane™ memory, NVM devices that use chalcogenide phase change material (for example, chalcogenide glass), a combination of one or more of the above, or other memory.

A power source (not depicted) provides power to the components of system 600. More specifically, power source typically interfaces to one or multiple power supplies in system 600 to provide power to the components of system 600. In one example, the power supply includes an AC to DC (alternating current to direct current) adapter to plug into a wall outlet. Such AC power can be renewable energy (e.g., solar power) power source. In one example, power source includes a DC power source, such as an external AC to DC converter. In one example, power source or power supply includes wireless charging hardware to charge via proximity to a charging field. In one example, power source can include an internal battery, alternating current supply, motion-based power supply, solar power supply, or fuel cell source.

In an example, system 600 can be implemented using interconnected compute sleds of processors, memories, storages, network interfaces, and other components. High speed interconnects can be used such as: Ethernet (IEEE 802.3), remote direct memory access (RDMA), InfiniBand, Internet Wide Area RDMA Protocol (iWARP), Transmission Control Protocol (TCP), User Datagram Protocol (UDP), quick UDP Internet Connections (QUIC), RDMA over Converged Ethernet (RoCE), Peripheral Component Interconnect express (PCIe), Intel QuickPath Interconnect (QPI), Intel Ultra Path Interconnect (UPI), Intel On-Chip System Fabric (IOSF), Omni-Path, Compute Express Link (CXL), Universal Chiplet Interconnect Express (UCIe), HyperTransport, high-speed fabric, NVLink, Advanced Microcontroller Bus Architecture (AMBA) interconnect, OpenCAPI, Gen-Z, Infinity Fabric (IF), Cache Coherent Interconnect for Accelerators (CCIX), 3GPP Long Term Evolution (LTE) (4G), 3GPP 5G, and variations thereof. Data can be copied or stored to virtualized storage nodes or accessed using a protocol such as NVMe over Fabrics (NVMe-oF) or NVMe.

Communications between devices can take place using a network that provides die-to-die communications; chip-to-chip communications; circuit board-to-circuit board communications; and/or package-to-package communications.

Embodiments herein may be implemented in various types of computing, smart phones, tablets, personal computers, and networking equipment, such as switches, routers, racks, and blade servers such as those employed in a data center and/or server farm environment. The servers used in data centers and server farms comprise arrayed server configurations such as rack-based servers or blade servers. These servers are interconnected in communication via various network provisions, such as partitioning sets of servers into Local Area Networks (LANs) with appropriate switching and routing facilities between the LANs to form a private Intranet. For example, cloud hosting facilities may typically employ large data centers with a multitude of servers. A blade comprises a separate computing platform that is configured to perform server-type functions, that is, a “server on a card.” Accordingly, each blade includes components common to conventional servers, including a main printed circuit board (main board) providing internal wiring (e.g., buses) for coupling appropriate integrated circuits (ICs) and other components mounted to the board.

In some examples, network interface and other embodiments described herein can be used in connection with a base station (e.g., 3G, 4G, 5G and so forth), macro base station (e.g., 5G networks), picostation (e.g., an IEEE 802.11 compatible access point), nanostation (e.g., for Point-to-MultiPoint (PtMP) applications), on-premises data centers, off-premises data centers, edge network elements, fog network elements, and/or hybrid data centers (e.g., data center that use virtualization, cloud and software-defined networking to deliver application workloads across physical data centers and distributed multi-cloud environments).

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation. A processor can be one or more combination of a hardware state machine, digital control logic, central processing unit, or any hardware, firmware and/or software elements.

Some examples may be implemented using or as an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner or syntax, for instructing a machine, computing device or system to perform a certain function. The instructions may be implemented using any suitable high-level, low-level, object-oriented, visual, compiled and/or interpreted programming language.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that actually make the logic or processor.

The appearances of the phrase “one example” or “an example” are not necessarily all referring to the same example or embodiment. Any aspect described herein can be combined with any other aspect or similar aspect described herein, regardless of whether the aspects are described with respect to the same figure or element. Division, omission, or inclusion of block functions depicted in the accompanying figures does not infer that the hardware components, circuits, software and/or elements for implementing these functions would necessarily be divided, omitted, or included in embodiments.

Some examples may be described using the expression “coupled” and “connected” along with their derivatives. These terms are not necessarily intended as synonyms for each other. For example, descriptions using the terms “connected” and/or “coupled” may indicate that two or more elements are in direct physical or electrical contact with each other. The term “coupled,” however, may also mean that two or more elements are not in direct contact with each other, but yet still co-operate or interact with each other.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced items. The term “asserted” used herein with reference to a signal denote a state of the signal, in which the signal is active, and which can be achieved by applying any logic level either logic 0 or logic 1 to the signal. The terms “follow” or “after” can refer to immediately following or following after some other event or events. Other sequences of steps may also be performed according to alternative embodiments. Furthermore, additional steps may be added or removed depending on the particular applications. Any combination of changes can be used and one of ordinary skill in the art with the benefit of this disclosure would understand the many variations, modifications, and alternative embodiments thereof.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present. Additionally, conjunctive language such as the phrase “at least one of X, Y, and Z,” unless specifically stated otherwise, should also be understood to mean X, Y, Z, or any combination thereof, including “X, Y, and/or Z.′”

Illustrative examples of the devices, systems, and methods disclosed herein are provided below. An embodiment of the devices, systems, and methods may include any one or more, and any combination of, the examples described below.

Example 1 includes one or more examples, and includes an apparatus comprising: an input/output (I/O) interface and circuitry, communicatively coupled to the interface, wherein the circuitry is to generate measurements for software attestation of a device and wherein the circuitry is a sole generator of the measurements for software attestation for the device.

Example 2 includes one or more examples, wherein the measurements are based on one or more of: firmware image file, software executable binary, device state, and/or fuse measurements.

Example 3 includes one or more examples, wherein to generate measurements for software attestation of the device, the circuitry is to perform a cryptographic hash over one or more of: firmware image file, software executable binary, device state, and/or fuse measurements.

Example 4 includes one or more examples, wherein the circuitry is to: verify the generated measurements based on a key retrieved from a one-time programmable memory.

Example 5 includes one or more examples, wherein the circuitry is to: create a key pair comprising a private key and a public key and provide the public key to a certificate authority.

Example 6 includes one or more examples, wherein the circuitry is to: insert the measurements into one or more messages, and sign the one or more messages based on the private key generated by the circuitry.

Example 7 includes one or more examples, wherein the circuitry is a sole inserter of the measurements into the one or more messages.

Example 8 includes one or more examples, wherein the circuitry is a sole signer of the one or more messages.

Example 9 includes one or more examples, wherein the one or more messages are based on a Security Protocol and Data Model (SPDM) protocol.

Example 10 includes one or more examples, wherein the device comprises one or more of: microcontroller, central processing unit (CPU), graphics processing unit (GPU), network interface device, accelerator, storage device, memory device, graphics processing unit, audio or sound processing device.

Example 11 includes one or more examples, and includes a method comprising: receiving, at circuitry, a request to generate measurements for attestation of software executed by a device; generating the measurements, at the circuitry; verifying the measurements, at the circuitry; and outputting the signed measurements, from the circuitry, wherein the circuitry is a sole generator of the measurements.

Example 12 includes one or more examples, wherein the measurements are based on one or more of: firmware image file, software executable binary, device state, and/or fuse measurements.

Example 13 includes one or more examples, wherein generating measurements comprises performing a cryptographic hash over one or more of: firmware image file, software executable binary, device state, and/or fuse measurements.

Example 14 includes one or more examples, and includes creating, by the circuitry, a key pair comprising a private key and a public key.

Example 15 includes one or more examples, wherein the outputting the signed measurements comprises: providing the signed measurements in one or more messages, and signing the one or more messages based on the private key generated by the circuitry.

Example 16 includes one or more examples, wherein the one or more messages are based on a Security Protocol and Data Model (SPDM) protocol.

Example 17 includes one or more examples, and includes a computer-readable medium comprising instructions stored thereon, that if executed by one or more processors, cause the one or more processors to: request a circuitry to provide measurements of configurations of a device, wherein the configurations of the device are based on a cryptographic hash of one or more of: firmware image file, software executable binary, device state, and/or fuse measurements, wherein the circuitry is a sole provider of the measurements.

Example 18 includes one or more examples, and includes instructions stored thereon, that if executed by one or more processors, cause the one or more processors to: request the circuitry to sign the measurements and request the circuitry to provide the signed measurements in one or more messages.

Example 19 includes one or more examples, and includes instructions stored thereon, that if executed by one or more processors, cause the one or more processors to: request the circuitry to generate a key pair comprising a private key and a public key and request the circuitry to sign the one or more messages based on the private key.

Example 20 includes one or more examples, wherein the one or more messages are based on a Security Protocol and Data Model (SPDM) protocol.

What is claimed is:

1. An apparatus comprising:
an input/output (I/O) interface and
circuitry, communicatively coupled to the interface, wherein the circuitry is to generate measurements for software attestation of a device and wherein the circuitry is a sole generator of the measurements for software attestation for the device.

2. The apparatus of claim 1, wherein the measurements are based on one or more of: firmware image file, software executable binary, device state, and/or fuse measurements.

3. The apparatus of claim 1, wherein to generate measurements for software attestation of the device, the circuitry is to perform a cryptographic hash over one or more of: firmware image file, software executable binary, device state, and/or fuse measurements.

4. The apparatus of claim 1, wherein the circuitry is to:
verify the generated measurements based on a key retrieved from a one-time programmable memory.

5. The apparatus of claim 1, wherein the circuitry is to:
create a key pair comprising a private key and a public key and
provide the public key to a certificate authority.

6. The apparatus of claim 5, wherein the circuitry is to:
insert the measurements into one or more messages, and
sign the one or more messages based on the private key generated by the circuitry.

7. The apparatus of claim 6, wherein the circuitry is a sole inserter of the measurements into the one or more messages.

8. The apparatus of claim 6, wherein the circuitry is a sole signer of the one or more messages.

9. The apparatus of claim 6, wherein the one or more messages are based on a Security Protocol and Data Model (SPDM) protocol.

10. The apparatus of claim 6, wherein the device comprises one or more of: microcontroller, central processing unit (CPU), graphics processing unit (GPU), network interface device, accelerator, storage device, memory device, graphics processing unit, audio or sound processing device.

11. A method comprising:
receiving, at circuitry, a request to generate measurements for attestation of software executed by a device;
generating the measurements, at the circuitry;
verifying the measurements, at the circuitry; and
outputting the signed measurements, from the circuitry, wherein the circuitry is a sole generator of the measurements.

12. The method of claim 11, wherein the measurements are based on one or more of: firmware image file, software executable binary, device state, and/or fuse measurements.

13. The method of claim 11, wherein generating measurements comprises performing a cryptographic hash over one or more of: firmware image file, software executable binary, device state, and/or fuse measurements.

14. The method of claim 11, comprising:
creating, by the circuitry, a key pair comprising a private key and a public key.

15. The method of claim 14, wherein the outputting the signed measurements comprises:
providing the signed measurements in one or more messages, and
signing the one or more messages based on the private key generated by the circuitry.

16. The method of claim 15, wherein the one or more messages are based on a Security Protocol and Data Model (SPDM) protocol.

17. A computer-readable medium comprising instructions stored thereon, that if executed by one or more processors, cause the one or more processors to:
request a circuitry to provide measurements of configurations of a device, wherein the configurations of the device are based on a cryptographic hash of one or more of: firmware image file, software executable binary, device state, and/or fuse measurements, wherein the circuitry is a sole provider of the measurements.

18. The computer-readable medium of claim 17, comprising instructions stored thereon, that if executed by one or more processors, cause the one or more processors to:
request the circuitry to sign the measurements and
request the circuitry to provide the signed measurements in one or more messages.

19. The computer-readable medium of claim 17, comprising instructions stored thereon, that if executed by one or more processors, cause the one or more processors to:
request the circuitry to generate a key pair comprising a private key and a public key and
request the circuitry to sign the one or more messages based on the private key.

20. The computer-readable medium of claim 19, wherein the one or more messages are based on a Security Protocol and Data Model (SPDM) protocol.
